(19) United States
(12) Patent Application Publication
(10) Pub. No.: US 2011/0286231 A1
(43) Pub. Date: Nov. 24, 2011

(54) VEHICLE LIGHTING DEVICE

(75) Inventor: Yoshihiro SUGIE, Isehara-shi (JP)

(73) Assignee: ICHIKOH INDUSTRIES, LTD.

(21) Appl. No.: 13/096,600

(22) Filed: Apr. 28, 2011

(30) Foreign Application Priority Data
May 20, 2010 (JP) 2010-116532

(51) Int. Cl. F21S 8/10

(52) U.S. Cl. 362/549

(57) ABSTRACT

It is important to securely fix a semiconductor-type light source 2 to a holding member 3 by means of a mount member 4 or a screw 5 so as to be durable against vibration of a vehicle. A vehicle lighting device according to the present invention is comprised of the semiconductor-type light source 2, the holding member 3, the mount member 4, and the screw 5. The semiconductor-type light source 2 is comprised of a board 20 and a main body. A placement face 30 on which the semiconductor-type light source 2 is to be placed is provided at the holding member 3. An opening portion 400 is provided at a site which corresponds to the board 20 of the semiconductor-type light source 2 of the mount member 4. A presser face 401 which is adapted to press the semiconductor-type light source 2 against the holding member 3 is provided at a circumferential edge part of the opening portion 400 of the mount member 4. As a result, the vehicle lighting device of the present invention enables the semiconductor-type light source 2 to be reliably fixed between the holding member 3 and the mount member 4 by mounting the screw 5 on the holding member 3 via the mount member 4 in a state in which the semiconductor-type light source 2 is sandwiched between the holding member 3 and the mount member 4.

### CROSS REFERENCE TO RELATED APPLICATIONS

This application claims priority of Japanese Patent Application No. 2010-116532 filed on May 20, 2010. The contents of this application are incorporated herein by reference in their entirety.

### BACKGROUND OF THE INVENTION

1. Field of the Invention

The present invention relates to a vehicle lighting device which uses a semiconductor-type light source as a light source.

2. Description of the Related Art

A vehicle lighting device of such type is conventionally known (for example, United State Patent Application Publication No. 2009/0096341). Hereinafter, a conventional vehicle lighting device will be described. In the conventional vehicle lighting device, an illumination module is fixed to a heat sink by means of a mount bracket.

In such a vehicle lighting device, it has been important to cause the illumination module to be securely fixed to the heat sink via the mount bracket so as to be durable for vibration of a vehicle.

The present invention has been made in order to solve the problem described above. In other words, it is an object of the present invention to provide a vehicle lighting device vehicle in view of the circumstance that, in the vehicle lighting device of such type, it has been important to cause the illumination module to be securely fixed to the heat sink via the mount bracket so as to be durable against vibration of a vehicle.

### SUMMARY OF THE INVENTION

A first aspect of the present invention is directed to a vehicle lighting device which allows a mount bracket to be mounted on a holding member via a mount fixture, in a state in which a semiconductor-type light source is sandwiched between the holding member and the mount member so as to thereby cause the semiconductor-type light source to be fixed between the holding member and the mount member, wherein: the semiconductor-type light source is comprised of a main body portion and a light emitting portion which is provided on one face of the main body portion; a placement face on which the other face of the main body portion of the semiconductor-type light source is to be placed is provided at the holding member; an opening portion is provided at a site which corresponds to a light emitting portion of the semiconductor-type light source of the mount member; and a presser face which is adapted to press one face of the main body portion against the placement face side of the holding member is provided at a circumferential edge part of the opening portion of the mount member.

In addition, a second aspect of the present invention is directed to the vehicle lighting device according to the first aspect of the present invention, wherein a protrusive portion which is more protrusive than the placement face is provided at a site at which the mount fixture of the holding member is to be mounted.

Further, a third aspect of the present invention is directed to the vehicle lighting device according to the first aspect of the present invention, wherein a gap is formed between the holding member and the mount member.

Furthermore, a fourth aspect of the present invention is directed to the vehicle lighting device according to the first aspect of the present invention, wherein: a first positioning portion which is adapted to perform positioning when another face of the main body portion of the semiconductor-type light source is placed on the placement face is provided at a respective one of the main body portion of the semiconductor-type light source and the holding member; and a second positioning portion which is adapted to perform positioning when the presser face of the mount member is placed on one face of the main body portion of the semiconductor-type light source is provided at a respective one of the main body portion and the mount member of the semiconductor-type light source.

Still furthermore, a fifth aspect of the present invention is directed to the vehicle lighting device according to the fourth aspect of the present invention, wherein: the first positioning portion is comprised of a hole portion and a protrusive portion which are provided in a vertical direction relative to the other face of the main body portion of the semiconductor-type light source and the placement face of the holding member and which engage with each other; and the second positioning portion is comprised of a hole portion and a protrusive portion which are provided in a vertical direction relative to one face of the main body portion of the semiconductor-type light source and a presser face of the mount member and which engage with each other.

In the vehicle lighting device according to the first aspect of the present invention, by means for solving the above-described problem, when a presser face of a mount member presses one face of a main body portion of a semiconductor-type light source against the placement face side of a holding member, such one face of the main body portion of the semiconductor-type light source and the presser face of the mount member securely abut against each other and the other face of the main body portion of the semiconductor-type light source and the placement face of the holding member securely abut against each other. In this state, the semiconductor-type light source is fixed to be sandwiched between the mount member and the holding member. As a result, the vehicle lighting device according to the first aspect of the present invention enables the semiconductor-type light source to be reliably fixed to the holding member via the mount member so as to be sufficiently durable against vibration of a vehicle.

In addition, in the vehicle lighting device according to the second aspect of the present invention, a protrusive portion which is more protrusive than a placement face is provided at a site at which a mount fixture of a holding member is to be mounted, so that a thickness of the site at which the mount fixture of the holding member is larger by the size for the protrusive portion in comparison with that of another site. As a result, the vehicle lighting device according to the second aspect of the present invention enables a mount interference for mounting a mount fixture such as a screw to be sufficiently allocated at the protrusive portion of the holding member, so that: the mount fixture such as the screw can be reliably mounted on the protrusive portion of the holding member; and the semiconductor-type light source can be fixed more reliably between the mount member and the holding member.

Moreover, in the vehicle lighting device according to the second aspect of the present invention, even in a case where two semiconductor-type light sources are fixed to be sandwiched between a placement face on one face of one holding member and a placement face of the other face by means of two mount members, a mount interference for reliably mounting two mount fixtures such as screws can be sufficiently allocated at a protrusive face of one face of the holding member and a protrusive portion of the other face, so that: the two mount fixtures such as the screws can be reliably mounted on the protrusive portion of one face of the holding member and the protrusive portion of the other face, respectively; and two semiconductor-type light sources can be reliably fixed between two mount members and one holding member, respectively.

Further, in the vehicle lighting device according to the third aspect of the present invention, when a mount fixture is mounted on a holding member via a mount member in a state in which a semiconductor-type light source is sandwiched between the holding member and the mount member, a force of mounting the mount fixture, for example, a screw tightening force acts as a force of pressing the mount member against the holding member side more significantly due to a gap between the holding member and the mount member, so that a presser face of the mount member can press one face of a main body portion of the semiconductor-type light source against the placement face side of the holding member further significantly. In this manner, the vehicle lighting device according to the third aspect of the present invention enables the semiconductor-type light source to be fixed further reliably between the holding member and the mount member.

Furthermore, in the vehicle lighting device according to the fourth aspect of the present invention, the other face of a main body portion of a semiconductor-type light source can be reliably placed in a predetermined location on a placement face of a holding member by means of a first positioning portion. In addition, a presser face of a mount member can be reliably placed in a predetermined location on one face of the main body portion of the semiconductor-type light source by means of a second positioning portion. As a result, the vehicle lighting device according to the fourth aspect of the present invention enables the semiconductor-type light source to be reliably fixed in a predetermined location between the holding member and the mount member. Moreover, in the vehicle lighting device according to the fourth aspect of the present invention, when the mount member is mounted on the semiconductor-type light source and the holding member by means of the mount fixture, the mount member can be easily mounted on the semiconductor-type light source and the holding member by means of the mount fixture without the mount member interfering with the semiconductor-type light source.

Still furthermore, in the vehicle lighting device according to the fifth aspect of the present invention, a hole portion and a protrusive portion of a first positioning portion engage with each other in a vertical direction relative to the other face of a main body portion of a semiconductor-type light source and a placement face of a holding member; and a hole portion and a protrusive portion of a second positioning portion engage with each other in a vertical direction relative to one face of the main body portion of the semiconductor-type light source and a presser face of a mount member. As a result, in the vehicle lighting device according to the fifth aspect of the present invention, by means of the hole portion and the protrusive portion engaging with each other, of the first positioning portion, and the hole portion and the protrusive portion engaging with each other, of the second positioning portion, the semiconductor-type light source that is fixed to be sandwiched between the mount member and the holding member can be reliably fixed without a backlash in a facial direction between one face of the main body portion of the semiconductor-type light source and the presser face of the mount member and between the other face of the main body portion of the semiconductor-type light source and the placement face of the holding member.

### BRIEF DESCRIPTION OF THE DRAWINGS

FIG. 1 is an exploded perspective view of essential portions (a semiconductor-type light source, a holding member, a mount member, and a mount fixture), the exploded perspective view showing a vehicle lighting device according to a first embodiment of the present invention;

FIG. 2 is an exploded perspective view showing a mount state of the essential portions (the semiconductor-type light source, the holding member, the mount member, and the mount fixture), i.e., a state in which the semiconductor-type light source is placed on the holding member, similarly;

FIG. 3 is a plan view showing a mount state of the essential portions (the semiconductor-type light source, the holding member, the mount member, and the mount fixture), similarly;

FIG. 4 is a sectional view which is taken along the line IV-IV in FIG. 3, similarly;

FIG. 5 is an exploded sectional view which is taken along the line IV-IV in FIG. 3, similarly;

FIG. 6 is a sectional view which is taken along the line VI-VI in FIG. 3, similarly;

FIG. 7 is an exploded sectional view which is taken along the line VI-VI in FIG. 3, similarly;

FIG. 8 is a longitudinal sectional view (a vertical sectional view) showing a reflection state of light which is radiated from the semiconductor-type light source, similarly;

FIG. 9 is a sectional view which corresponds to the sectional view taken along the line IV-IV in FIG. 3, of essential portions (two semiconductor-type light source, one holding member, two mount members, and two sets of mount fixtures), the sectional view showing a vehicle lighting device according to a second embodiment of the present invention, similarly; and

FIG. 10 is a longitudinal sectional view (a vertical sectional view) of the essential portions (two semiconductor-type light source, one holding member, two mount members, and two sets of mount fixtures), similarly.

### DESCRIPTION OF THE PREFERRED EMBODIMENTS

Hereinafter, two embodiments of the preferred embodiments of a vehicle lighting device according to the present invention will be described in detail with reference to the drawings. It should be noted that these embodiments do not limit the present invention. In the specification and claims, terms “top”, “bottom”, “front”, “rear”, “left”, and “right” denote the “top”, “bottom”, “front”, “rear”, “left”, and “right” of a vehicle, respectively, when the vehicle lighting device according to the present invention is mounted on a vehicle (an automobile).

### First Embodiment

(Description of Configuration)

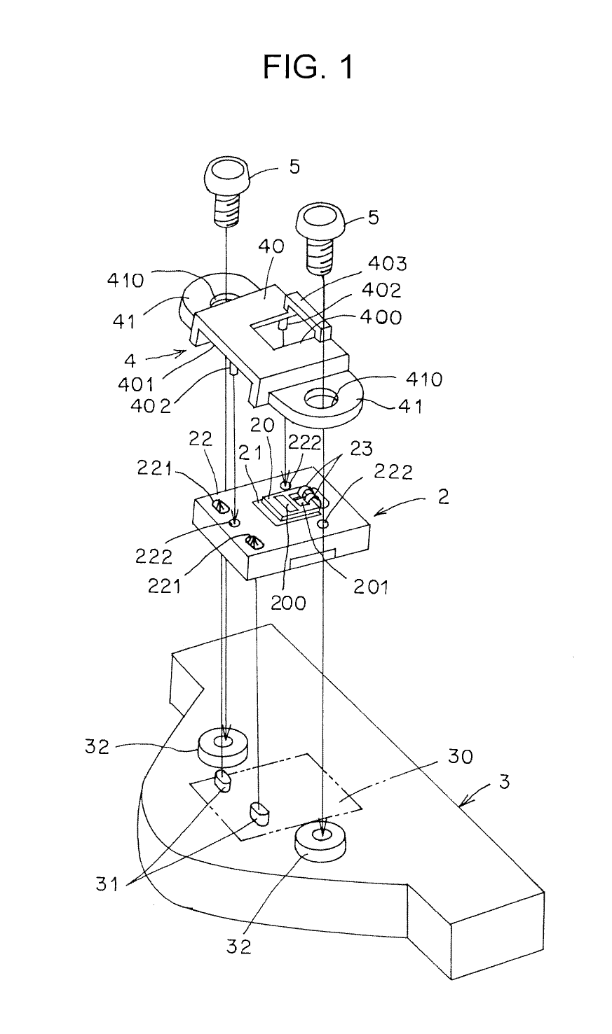

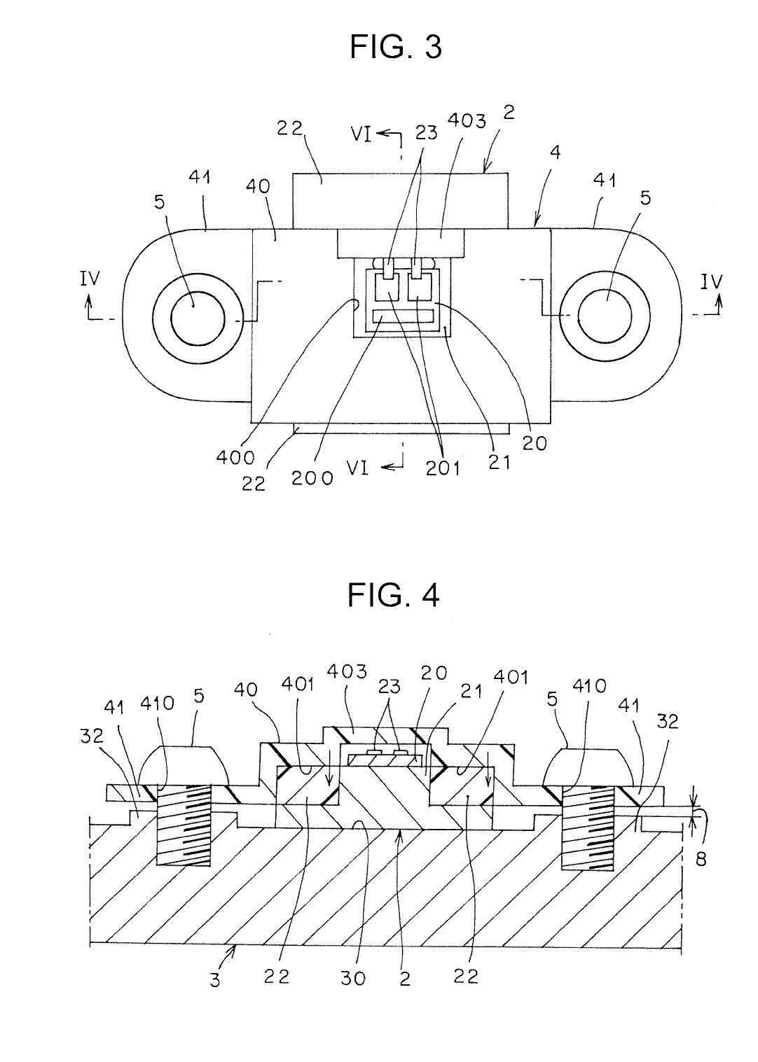

FIG. 1 to FIG. 8 each show a vehicle lighting device according to a first embodiment of the present invention. Hereinafter, a configuration of the vehicle lighting device in the first embodiment will be described. In FIG. 3, a holding member 3 is not shown.

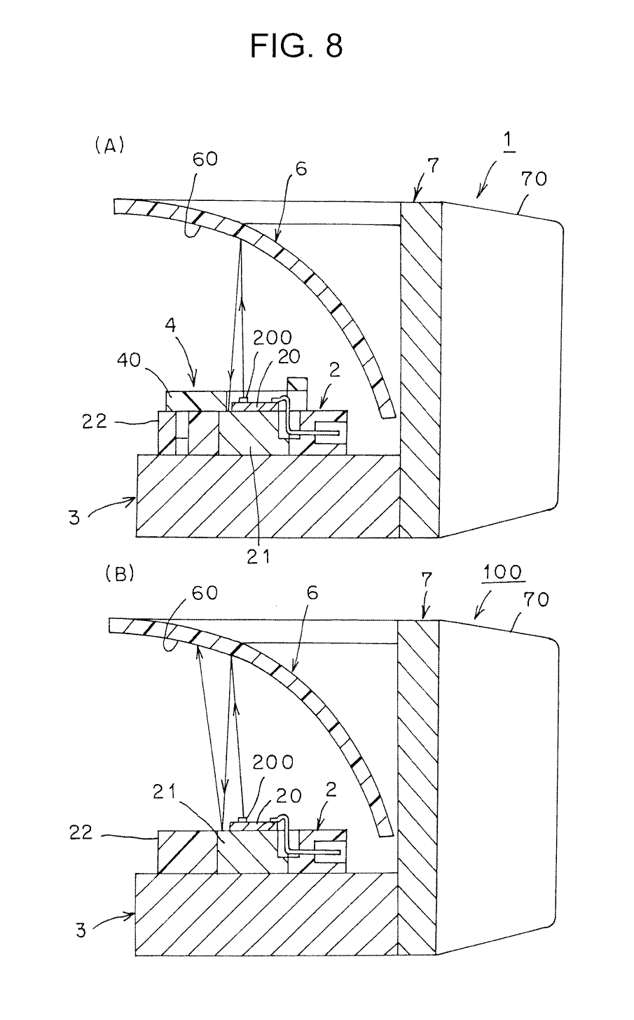

In FIG. 8, reference numeral 1 designates a vehicle lighting device in the first embodiment (for example, an automobile headlamp such as a headlamp, for example). The vehicle lighting device 1 is comprised of a semiconductor-type light source (for example, an LED module) 2; a holding member (for example, a base or a holder) 3; a mount member (for example, a cover or a cover member) 4; a mount fixture, a screw 5 shown as an example thereof; a reflector 6; a heat sink 7; and a lamp housing and a lamp lens (such as a transparent outer lens, for example), although not shown.

The semiconductor-type light source 2, the holding member 3, the mount member 4, the screw 5, the reflector 6, and the heat sink 7 form a lamp unit. The lamp unit formed by the constituent elements designated by reference numerals 2, 3, 4, 5, 6, and 7 is disposed in a lamp room partitioned by the lamp housing and the lamp lens via an optical axis adjustment mechanism, for example. In the lamp room, there may be disposed the other lamp unit such as a cornering lamp, a clearance lamp, or a turn signal lamp other than the lamp unit formed by the constituent elements designated by reference numerals 2, 3, 4, 5, 6, and 7.

The semiconductor-type light source 2 is comprised of: a board 20 that serves as a light emitting portion; a thermal conductive member 21 and an insulation member 22 that serve as a main body portion; and two terminals 23. The board 20, the thermal conductive member 21, the insulation member 22, and the terminals 23 are integrally incorporated in appropriate location.

The board 20 is formed in the shape of a rectangular plate. On one face (a top face) of the board 20, a light emitting chip 200, two electrodes 201, and circuits or parts or the like (not shown) for controlling a current to be supplied from the electrodes 201 to the light emitting chip 200 are mounted, respectively. A sealing member (not shown) is applied to one face of the board 20. It is sufficient if the sealing member is applied to at least the electrodes 201. The light emitting chip 200 is made of a plurality of square chips arranged in one direction. One rectangular chip may be used.

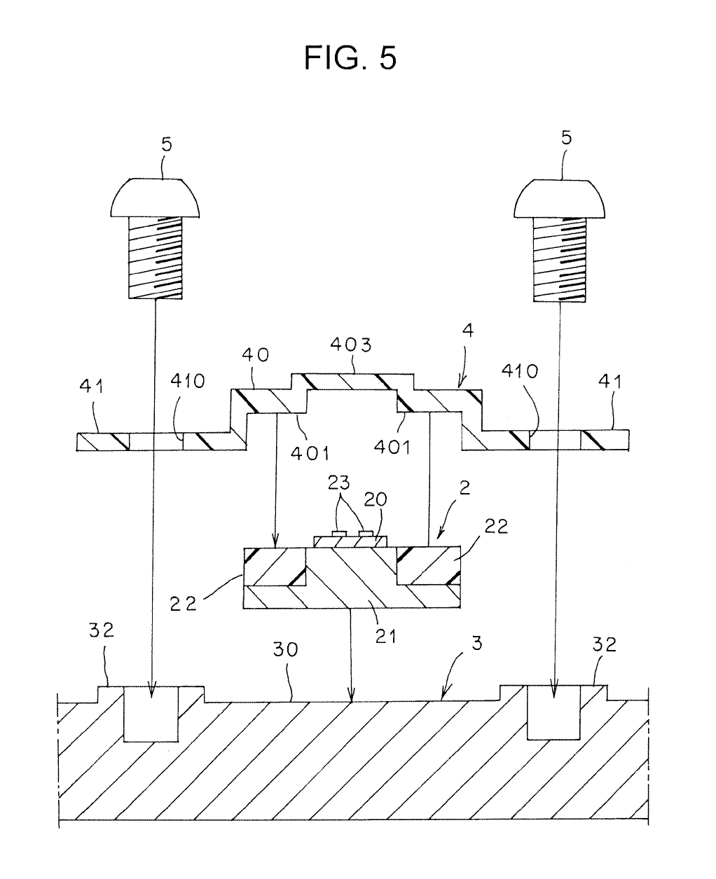

The thermal conductive member 21 is comprised of a metal member or a resin member having its high thermal conductivity, for example. The thermal conductive member 21, as shown in FIG. 4 and FIG. 5, is formed in a sectional inverted T-shape. On the other hand, the insulation member 22 is comprised of a member having its insulation property. The insulation member 22 is formed in a rectangular parallelepiped shape. The thermal conductive member 21 and the insulation member 22 are integrally constructed by means of insert molding or the like.

One face (a top face) of the heat conducing member 21 and one face (a top face) of the insulation member 22 are in flush with each other. One face of the thermal conductive member 21 is formed in a rectangular shape which is larger than that of the board 20 by one size, and is positioned at a center on one face of the insulation member 22. On one face of the thermal conductive member 21, the other face (a bottom face) of the board 20 is fixed by means of an adhesive bond or the like (not shown).

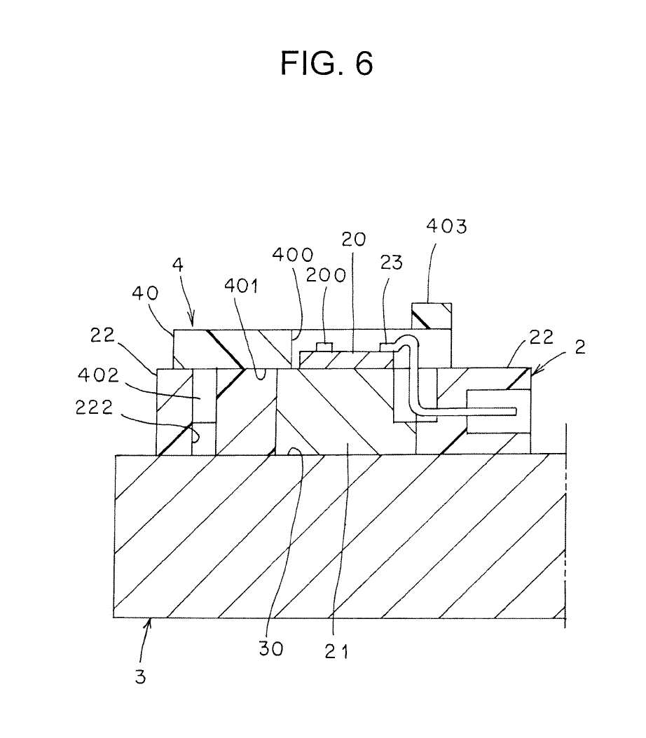

The other face (a bottom face of the thermal conductive member 21 and the other face (a bottom face) of the insulation member 22 are in flush with each other. The other face of the thermal conductive member 21, as shown in FIG. 6 to FIG. 8, is positioned at an intermediate part of the other face of the insulation member 22.

At each side (each of the left and right sides) of one end part (a front end part) of the insulation member 22, a first positioning hole portion 221 formed in a small elongated circular shape is provided in a vertical direction relative to a respective one of one face and the other face of the insulation member 22. In addition, at a respective one of a center of one end part of the insulation member 22 and each side (each of the left and right sides) of the other end part (a rear end part), a second positioning hole portion 222 formed in a small circular shape is provided in a vertical direction relative to a respective one of one face and the other face of the insulation member 22.

The terminals 23 are integrally constructed at the center of the other end part of the insulation member 22 by means of insert molding, for example. One end part of a respective one of the terminals 23 is curved upward, and is electrically connected to the electrode 201 of the board 20. In addition, an intermediate portion of the terminal 23, as shown in FIG. 6 to FIG. 8, is housed in a vertical state in the thermal conductive member 21 and the insulation member 22. Further, the other end part of the terminal 23, as shown in FIG. 6 to FIG. 8, is horizontally bent, and configures a connector portion together with the center at the other end part of the insulation member 22. The connector portion is electrically connected to a power source side by means of a connector (not shown) at the power source side being removably mounted thereon.

The holding member 3 is comprised of a metal member or a resin member having its thermal conductivity. The holding member 3 is formed in a planar shape. A placement face 30 is provided at the center on one face (a top face) of the holding member 3. At each side (each of the left and right sides) of one end part (a front end part) of the placement face 30 of the holding member 3, a first positioning protrusive portion 31 formed in a small elongated circular shape is integrally protruded in a vertical direction relative to the placement face 30 of the holding member 3 and in correspondence with the first positioning hole portion 221.

In the holding member 3, at a site into which the screw 5 is to be screwed, i.e., at a site which is spaced from the placement face 30 and at each side (each of the left and right sides) of the placement face 30, a protrusive portion 32 which is more protrusive than the placement face 30 is integrally provided. At the protrusive portion 32, a through hole or a screw hole is provided.

The mount member 4 is comprised of a member which is adapted to scatter (randomly reflect) light or absorb light or a member having its low reflection factor. The mount member 4 is comprised of: a covering portion 40; and a mount portion 41 which is integrally provided at each side (each of the left and right sides) of the covering portion 40. The covering portion 40 is formed in a reversed recessed shape which is adapted to cover almost all of one face of the insulation member 22 of the semiconductor-type light source 2 and sandwich each side face (each of the left and right side faces) of the insulation member 22 of the semiconductor-type light source 2.

An opening portion 400 is provided at a central part of the covering portion 40 and at a site which corresponds to the board 20 of the semiconductor-type light source 2. The opening portion 400 is formed in a rectangular shape which is smaller by one size than one face of the thermal conductive member 21 that is exposed on one face of the insulation member 22 of the semiconductor-type light source 2 and which is larger by one size than the board 20.

A presser face 401 is provided at a circumferential edge part of the opening portion 400 of the covering portion 40 and on a face opposite to one face of the insulation member 22 of the semiconductor-type light source 2, the presser face 401 being adapted to press one face of the insulation member 22 of the semiconductor-type light source 2 against the side of placement face 30 of the holding member 3. At the center of one end part (a front end part) of the presser face 401 of the covering portion 40 and at each side (each of the left and right sides) of the other end part (a rear end part), a second positioning protrusive portion 402 formed in a small circular shape is integrally protruded in a vertical direction relative to the presser face 401 of the covering portion 40 and in correspondence with the second positioning hole portion 222.

A portion 403, which is provided at the circumferential edge part of the opening portion 400 of the covering portion 40 and which corresponds to the terminal 23 of the semiconductor-type light source 2, is formed in an erected shape. This erected portion 403 is provided at a site other than from one end part of the terminal 23 that is curved upward. At a respective one of the two mount portions 41, a circular through hole 410 is provided in correspondence with the protrusive portion 32 of the holding member 3.

Hereinafter, a description will be given with respect to a process for fixing the semiconductor-type light source 2 to be sandwiched between the holding member 3 and the mount member 4.

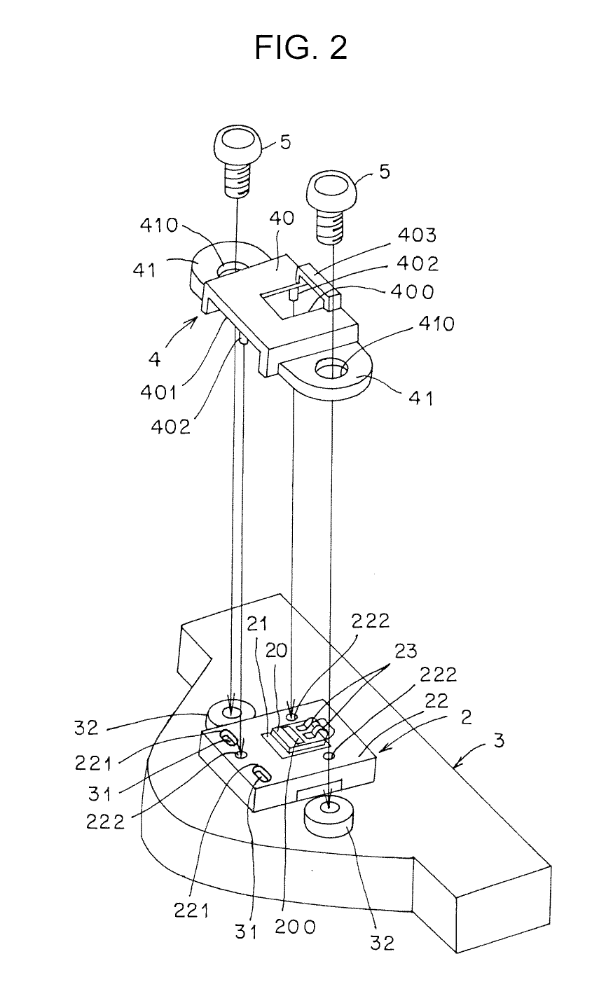

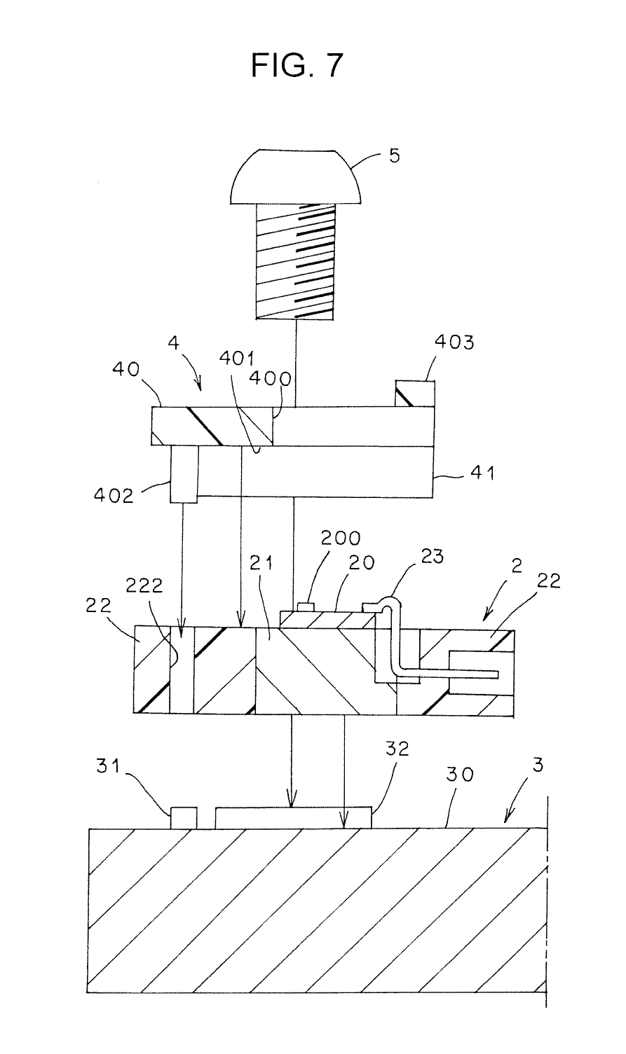

First, the other face of a main body portion of the semiconductor-type light source 2, i.e., the other face of the thermal conductive member 21 and the insulation member 22, is mounted on the placement face 30 of the holding member 3. At this time, the first positioning protrusive portion 31 of the holding member 3 and the first positioning hole portion 221 of the semiconductor-type light source 2 engage with each other and then the other face of the thermal conductive member 21 and the insulation member 22 that serve as the main body portion of the semiconductor-type light source 2 is placed in a state in which it is positioned in a predetermined location of the placement face 30 of the holding member 3 (see FIG. 1, FIG. 2, FIG. 5, and FIG. 7).

Next, the presser face 401 of the covering portion 40 of the mount member 4 is placed on one face of the thermal conductive member 21 and the insulation member 22 that serve as the main body portion of the semiconductor-type light source 2. At this time, the second positioning hole portion 222 of the semiconductor-type light source 2 and the second positioning protrusive portion 402 of the mount member 4 engage with each other and then the presser face 401 of the covering portion 40 of the mount member 4 is placed in a state in which it is positioned in a predetermined location of one face of the thermal conductive member 21 and the insulation member 22 that serve as the main body portion of the semiconductor-type light source 2 (see FIG. 2, FIG. 4, and FIG. 6).

In other words, the opening portion 400 of the covering portion 40 of the mount member 4 is positioned at a light emitting portion of the semiconductor-type light source 2, i.e., on the board 20. In addition, the mount portion 41 of the mount member 4 is positioned at the protrusive portion 32 of the holding member 3.

Then, a mount fixture, i.e., a screw 5 is inserted into the through hole 410 of the mount portion 41 of the mount member 4, and is screwed into a through hole or a screw hole of the protrusive portion 32 of the holding member 3. Subsequently, as indicated by the solid arrow in FIG. 4, the presser face 401 of the covering portion 40 of the mount member 4 presses one face of the thermal conductive member 21 and the insulation member 22 that serve as the main body portion of the semiconductor-type light source 2 against the side of the placement face 30 of the holding member 3. As a result, one face of the thermal conductive member 21 and the insulation member 22 that serve as the main body portion of the semiconductor-type light source 2 and the pressure face 401 of the covering portion 40 of the mount member 4 securely abut against each other and the other face of the thermal conductive member 21 and the insulation member 22 that serve as the main body portion of the semiconductor-type light source 2 and the placement face 30 of the holding member 3 securely abut against each other. In this state, the semiconductor-type light source 2 is fixed to be sandwiched between the mount member 4 and the holding member 3.

At this time, as shown in FIG. 4, a gap 8 is formed between the holding member 3 and the mount member 4. In other words, in the holding member 3, the gap 8 is formed between: a face of the holding member 3 other than the placement face 30 on which the semiconductor-type light source 2 is placed, the face serving as one face (a top face) of the protrusive portion 32 of the holding member 3; and a face of the mount member 4 other than the presser face 401 that is adapted to press the semiconductor-type light source 2, the face serving as the other face (a bottom face) of the mount portion 41 of the mount member 4.

The reflector 6 is comprised of an optically opaque resin member, for example, the reflector 6 is formed in a shape of which a front portion and a bottom portion open and other portions (a top portion, a rear portion, and each of the left and right portions) close. A reflection surface 60 is provided on an interior face of the reflector 6. The reflection surface 60 is adapted to forwardly reflect and emit light from the light emitting chip 200 of the semiconductor-type light source 2 as a predetermined light distribution pattern.

The heat sink 7 is comprised of a resin member or a metal member having its high thermal conductivity. The heat sink 7 forms a heat radiation portion 70 of which a front portion is formed in a planar shape and a portion ranging from an intermediate portion to a rear portion is formed in the shape of a fin. The reflector 6 and the heat sink 7 are mounted on the holding member 3.

(Description of Functions)

The vehicle lighting device 1 in the first embodiment is made of the constituent elements described above. Hereinafter, functions of this vehicle lighting device will be described.

A light emitting chip 200 of a semiconductor-type light source 2 of the vehicle lighting device 1 is illuminated to emit light. Then, light is radiated from the light emitting chip 200 of the semiconductor-type light source 2. The radiated light is reflected on a reflection surface 60 of a reflector 6 and then the reflected light is emitted forward of a vehicle as a predetermined light distribution pattern.

(Description of Advantageous Effect)

The vehicle lighting device 1 in the first embodiment is made of the constituent elements and functions described above. Hereinafter, advantageous effect of this vehicle lighting device will be described.

According to the vehicle lighting device 1 in the first embodiment, when a presser face 401 of a covering portion 40 of a mount member 4 presses one face of a thermal conductive member 21 and an insulation member 22 that serve as a main body of a semiconductor-type light source 2 against the side of a placement face 30 of a holding member 3, such one face of the thermal conductive member 21 and the insulation member 22 that serve as the main body portion of the semiconductor-type light source 2 and the presser face 401 of the covering portion 40 of the mount member 4 securely abut against each other and the other face of the thermal conductive member 21 and the insulation member 22 that serve as the man body portion of the semiconductor-type light source 2 and the placement face 30 of the holding member 3 securely abut against each other. In this state, the semiconductor-type light source 2 is fixed to be sandwiched between the mount member 4 and the holding member 3. As a result, the vehicle lighting device 1 in the first embodiment enables the semiconductor-type light source 2 to be reliably fixed to the holding member 3 via the mount member 4 so as to be sufficiently durable against vibration of a vehicle.

In addition, according to the vehicle lighting device 1 in the first embodiment, in the holding member 3, a protrusive portion 32 which is more protrusive than the placement face 30 is provided at a site at which a mount portion 41 of a mount fixture 4 is to be mounted, so that in the holding member 3, a thickness of the site at which the mount portion 41 of the mount fixture 4 is to be mounted becomes larger by the size for protrusive portion 32 in comparison with that of another site. As a result, according to the vehicle lighting device 1 in the first embodiment, a mount interface for reliably mounting a screw 5 that serves as a mount fixture at the protrusive portion 32 of the holding member 3 can be sufficiently allocated. Therefore, the screw 5 that serves as the mount fixture can be reliably mounted on the protrusive portion 32 of the holding member 3, and the semiconductor-type light source 2 can be fixed further reliably between the mount member 4 and the holding member 3.

Further, according to the vehicle lighting device 1 in the first embodiment, in a state in which the semiconductor-type light source 2 is sandwiched between the holding member 3 and the mount member 4, when the screw 5 is mounted on the protrusive portion 32 of the holding member 3 via the mount portion 41 of the mount member 4, as shown in FIG. 4, a force of tightening the screw 5 that serves as a mount fixture acts further significantly as a force of pressing the mount member 4 against the side of the holding member 3 due to the gap 8 between the holding member 3 and the mount member 4, i.e., the gap 8 of the holding member 3 between a face other than the placement face 30 on which the semiconductor-type light source 2 is placed, the face being one face (a top face) of the protrusive portion 32 of the holding member 3, and a face of the mount member 4 other than the presser face 401 which is adapted to press the semiconductor-type light source 2, the face being the other face (a bottom face) of the mount portion 41 of the mount member 4. Therefore, the presser face 401 of the covering portion 40 of the mount member 4 can press, with a further greater force, one face of the thermal conductive member 21 and the insulation member 22 that serve as the main body portion of the semiconductor-type light source 2, against the side of the placement face 30 of the holding member 3. In this manner, the vehicle lighting device 1 in the first embodiment enables the semiconductor-type light source 2 to be fixed further reliably between the holding member 3 and the mount member 4.

Furthermore, according to the vehicle lighting device 1 in the first embodiment, by means of first positioning portions, i.e., a first positioning hole portion 221 at the side of the semiconductor-type light source 2 and a first positioning protrusive portion 31 at the side of the holding member 3, both of which engage with each other, the other face of the thermal conductive member 21 and the insulation member 22 that serve as the main body portion of the semiconductor-type light source 2 can be reliably placed in a predetermined location on the placement face 30 of the holding member 3. In addition, by means of second positioning portions, i.e., a second positioning hole portion 222 at the side of the semiconductor-type light source 2 and a second positioning protrusive portion 402 at the side of the mount member 4, both of which engage with each other, the presser face 401 of the covering portion 40 of the mount member 4 can be reliably placed in a predetermined location on one face of the thermal conductive member 21 and the insulation member 22 that serve as the main body portion of the semiconductor-type light source 2. As a result, the vehicle lighting device 1 in the first embodiment enables the semiconductor-type light source 2 to be reliably fixed in a predetermined location between the holding member 3 and the mount member 4. Moreover, according to the vehicle lighting device 1 in the first embodiment, when the mount member 4 is mounted on the semiconductor-type light source 2 and the holding member 3 by means of the screw 5, the mount member 4 can be easily mounted on the semiconductor-type light source 2 and the holding member 3 by means of the screw 5 without the mount member 4 interfering with the semiconductor-type light source 2.

Still furthermore, according to the vehicle lighting device 1 in the first embodiment, the first positioning hole portion 221 at the side of the semiconductor-type light source 2 and the first positioning protrusive portion 31 at the side of the holding member 3 engage with each other in a vertical direction relative to the other face of the thermal conductive member 21 and the insulation member 22 that serve as the main body portion of the semiconductor-type light source 2 and the placement face 30 of the holding member 3; and the second positioning hole portion 222 at the side of the semiconductor-type light source 2 and the second positioning protrusive portion 402 at the side of the mount member 4 engage with each other in a vertical direction relative to one face of the thermal conductive member 21 and the insulation member 22 that serve as the main body portion of the semiconductor-type light source 2 and the presser face 401 of the covering portion 40 of the mount member 4. As a result, according to the vehicle lighting device 1 in the first embodiment, by means of the first positioning hole portion 221 at the side of the semiconductor-type light source 2 and the first positioning protrusive portion 31 at the side of the holding member 3, both of which engage with each other, and by means of the second positioning hole portion 222 at the side of the semiconductor-type light source 2 and the second positioning protrusive portion 402 at the side of the mount member 4, both of which engage with each other, the semiconductor-type light source 2 that is fixed to be sandwiched between the mount member 4 and the holding member 3 can be reliably fixed without a backlash in a facial direction of the placement face 30 of the holding member 3 between: one face of the thermal conductive member 21 and the insulation member 22 that serve as the main body portion of the semiconductor-type light source 2 and the presser face 401 of the covering portion 40 of the mount member 4; and the other face of the thermal conductive member 21 and the insulation member 22 that serve as the main body portion of the semiconductor-type light source 2.

In particular, according to the vehicle lighting device 1 in the first embodiment, the covering portion 40 that is adapted to cover the thermal conductive member 21 and the insulation member 22 that serve as the main body portion of the semiconductor-type light source 2 is provided at the mount member 4; and an opening portion 400 at which a board 20 for a light emitting portion of the semiconductor-type light source 2 is positioned is provided at the covering portion 40 of the mount member 4, wherein a size of the opening portion 400 at the covering portion 40 of the mount member 4 is smaller by one size than that of one face of the thermal conductive member 21 that is exposed on one face of the insulation member 22 of the semiconductor-type light source 2 and is larger by one size than that of the board 20.

As a result, according to the vehicle lighting device 1 in the first embodiment, as shown in FIG. 8(A), a part of one face of the thermal conductive member 21 of the semiconductor-type light source 2 is covered with a circumferential edge part of the opening portion 400 at the covering portion 40 of the mount member 4. Therefore, even in a case where the thermal conductive member 21 of the semiconductor-type light source 2 is made of a metal member, one face of which becomes a mirror face, the light from the light emitting chip 200 of the semiconductor-type light source 2, the light having been reflected on a reflection surface 60 of a reflector 6, is reflected after being allowed to be incident to one face of the thermal conductive member 21 of the semiconductor-type light source 2, the reflected light is shaded by means of a wall face of the opening portion 400 at the covering portion 40 of the mount member 4 which is comprised of a member adapted to scatter (randomly reflect) light or absorb light or a member having its low reflection factor and then the shaded reflected light is disallowed to be incident to the reflection surface 60 of the reflector 6 again.

On the other hand, in the case of a vehicle lighting device 100 shown in FIG. 8(B), i.e., in the case of the vehicle lighting device 100 in which the covering portion 40 that is adapted to cover the thermal conductive member 21 and the insulation member 22 that serve as the main body portion of the semiconductor-type light source 2 is not provided at the mount member 4, if the light from the light emitting chip 200 of the semiconductor-type light source 2, the light having been reflected on the reflection surface 60 of the reflector 6, is reflected after being allowed to be incident to one face of the thermal conductive member 21 of the semiconductor-type light source 2, the reflected light is reflected after being allowed to be incident to the reflection surface 60 of the reflector 6 again without being shaded by means of the wall face of the opening portion 400 at the covering portion 40 of the mount member 4 and then the reflected light may be emitted forward of a vehicle as light which is not controlled to be optically distributed.

However, according to the vehicle lighting device 1 in the first embodiment, as shown in FIG. 8(A) as described previously, even if the light from the light emitting chip 200 of the semiconductor-type light source 2, the light having been reflected on the reflection surface 60 of the reflector 6, is reflected after being allowed to be incident to one face of the thermal conductive member 21 of the semiconductor-type light source 2, the reflected light is shaded by means of the wall face of the opening portion 400 at the covering portion 40 of the mount member 4 and then the shaded reflected light is disallowed to be incident to the reflection surface 60 of the reflector 6 again; and therefore, the light that is not controlled to be optically distributed is disallowed to be emitted forward of a vehicle.

### Second Embodiment

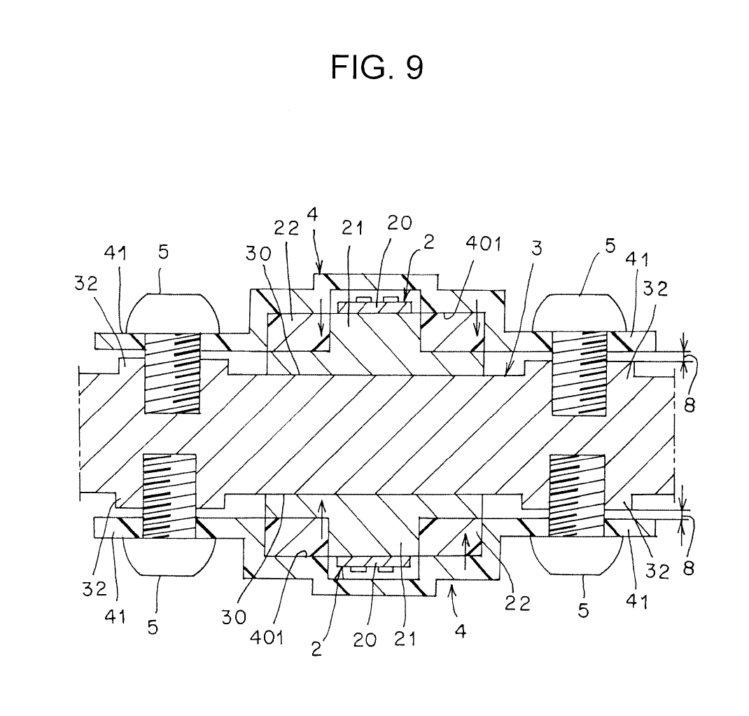

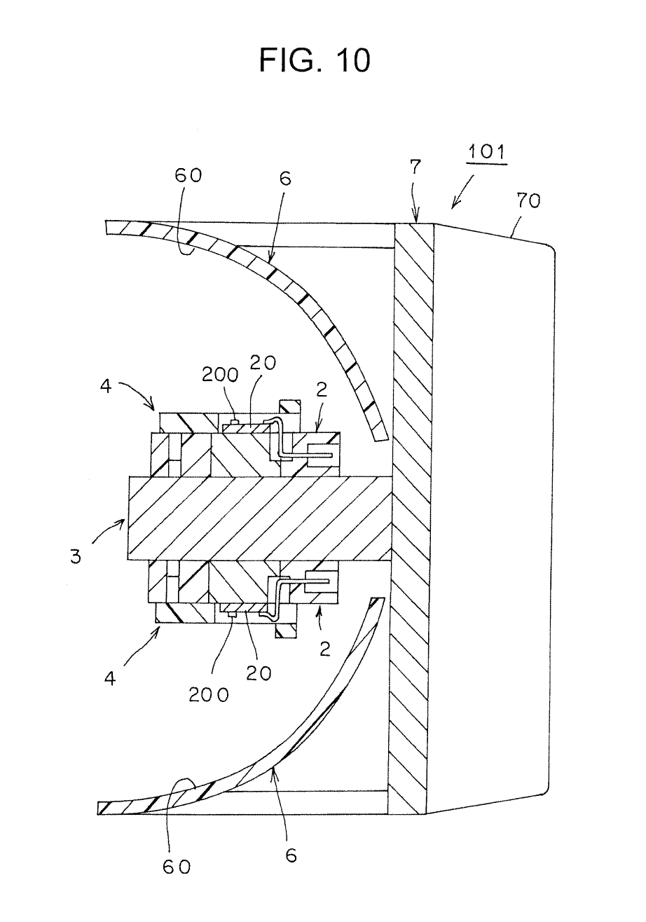

FIG. 9 and FIG. 10 show a vehicle lighting device according to a second embodiment of the present invention. Hereinafter, the vehicle lighting device in the second embodiment will be described. In the figures, like constituent elements shown in FIG. 1 to FIG. 8 are designated by like reference numerals.

According to a vehicle lighting device 101 in the second embodiment, two semiconductor-type light sources 2, 2 are fixed to be sandwiched between a placement face 30 on one face (a top face) of one holding member 3 and a placement face 30 on the other face (a bottom face), respectively, by means of two mount members 4, 4.

The vehicle lighting device 101 in the second embodiment is made of the constituent elements described above; and therefore, there can be achieved functions and advantageous effect which are substantially similar to those of the vehicle lighting device 1 in the first embodiment described previously. Moreover, according to the lighting device 101 in the second embodiment, even in a case where two semiconductor-type light sources 2, 2 are fixed to be sandwiched between the placement face 30 on one face of one holding member 3 and the placement face on the other face, respectively, by means of two mount members 4, 4, a mount interface for reliably mounting a screw 5 that serves as a mount fixture can be sufficiently allocated between a protrusive portion 32 on one face of the holding member 3 and a protrusive portion 32 on the other face. Therefore, top and bottom screws 5 can be reliably mounted on the protrusive portion 32 of one face of the holding member 3 and the protrusive portion 32 of the other face, respectively, without the top and bottom screws 5 interfering with each other, and the two semiconductor-type light sources 2, 2 can be reliably fixed respectively between the two mount members 4, 4 and one holding member 3.

### Other Examples

In the first and second embodiments described previously, a screw 5 is used as a mount fixture. However, in the present invention, there may be used any mount fixture other than such a screw, for example, an elastic engagement between an elastic engagement claw portion and an engagement portion (a so called patching engagement), swaging by a swaging pin, or mounting by a bolt nut or the like.

In addition, in the first and second embodiments described previously, a fixed reflector is used as a reflector 6. However, in the present invention, by using a fixed reflector and a movable reflector as reflectors, a first light distribution pattern (for example, a low beam light distribution pattern) and a second light distribution pattern (for example, a high beam light distribution pattern) may be obtained interchangeably.

Further, in the first and second embodiments described previously, a vehicle a lighting device is used as a headlamp. However, in the present invention, the vehicle lighting device may be used for a fog lamp, a tail lamp, a daytime running lamp, a curve lamp or the like.

Furthermore, in the first and second embodiments described previously, a holding member 3 and a heat sink 7 are used separately. However, in the present invention, these holding member and heat sink may be used integrally.

Still furthermore, in the first and second embodiments described previously, a first positioning hole portion 221 and a second positioning hole portion 222 are used as a first positioning portion and a second positioning portion. However, in the present invention, recessed portions may be used as the first positioning portion and the second positioning portion without being limitative to the hole portions.

Yet furthermore, in the first and second embodiments described previously, a mount member 4 is comprised of a member adapted to scatter (randomly reflect) light or absorb light or a member having its low reflection factor. However, in the present invention, light absorption processing may be applied to a surface at a circumferential edge part of an opening portion of a mount member without limiting a member used as a mount member in particular.

What is claimed is:

1. A vehicle lighting device using a semiconductor-type light source as a light source, said vehicle lighting device comprising:
the semiconductor-type light source;
a holding member;
a mount member; and
a mount fixture, being mounted on the holding member via the mount fixture in a state in which the semiconductor-type light source is sandwiched between the holding member and the mount member so as to thereby cause the semiconductor-type light source to be fixed between the holding member and the mount member, wherein:
the semiconductor-type light source is comprised of a main body portion and a light emitting portion which is provided on one face of the main body portion;
a placement face on which the other face of the main body portion of the semiconductor-type light source is to be placed is provided at the holding member;
an opening portion is provided at a site which corresponds to a light emitting portion of the semiconductor-type light source of the mount member; and
a presser face which is adapted to press one face of the main body portion against the placement face side of the holding member is provided at a circumferential edge part of the opening portion of the mount member.

2. The vehicle lighting device according to claim 1, wherein
a protrusive portion which is more protrusive than the placement face, is provided at a site at which the mount fixture of the holding member is to be mounted.

3. The vehicle lighting device according to claim 1, wherein
a gap is formed between the holding member and the mount member.

4. The vehicle lighting device according to claim 1, wherein:
a first positioning portion which is adapted to perform positioning when another face of the main body portion of the semiconductor-type light source is placed on the placement face is provided at a respective one of the main body portion of the semiconductor-type light source and the holding member; and
a second positioning portion which is adapted to perform positioning when the presser face of the mount member is placed on one face of the main body portion of the semiconductor-type light source is provided at a respective one of the main body portion and the mount member of the semiconductor-type light source.

5. The vehicle lighting device according to claim 4, wherein:
the first positioning portion is comprised of a hole portion and a protrusive portion which are provided in a vertical direction relative to the other face of the main body portion of the semiconductor-type light source and the placement face of the holding member and which engage with each other; and
the second positioning portion is comprised of a hole portion and a protrusive portion which are provided in a vertical direction relative to one face of the main body portion of the semiconductor-type light source and a presser face of the mount member and which engage with each other.
